(19) United States
(12) Patent Application Publication
(10) Pub. No.: US 2016/0301277 A1
(43) Pub. Date: Oct. 13, 2016

(54) STATOR FOR AN ELECTRONICALLY COMMUTATED DIRECT CURRENT MOTOR

(71) Applicant: PIERBURG GMBH, NEUSS (DE)

(72) Inventors: MARTIN NOWAK, LEVERKUSEN (DE); ANDREAS BURGER, KREFELD (DE); STEFAN ROTHGANG, RHEINBERG (DE); HENDRIK FERNER, KAARST (DE)

(73) Assignee: PIERBURG GMBH, NEUSS (DE)

(21) Appl. No.: 15/100,639

(22) PCT Filed: Nov. 19, 2014
(86) PCT No.: PCT/EP2014/075025

§ 371 Date: Jun. 1, 2016

(30) Foreign Application Priority Data
Dec. 3, 2013 (DE) 10 2013 113 363.0

(51) Int. Cl. H02K 3/52; H02K 5/22; H02K 3/38; H02K 1/14; H02K 3/28

(52) U.S. Cl. CPC H02K 3/522; H02K 1/146; H02K 3/28; H02K 3/38; H02K 5/225; H02K 2203/09

(57) ABSTRACT

A stator includes a stator stack comprising stator poles, a groove arranged between each of the stator poles, and a coil winding comprising a winding end arranged on each of the stator poles. The winding ends comprise cophasal coil windings and non-cophasal coil windings. A guiding body comprises an axial surface arranged opposite to the stator stack, a wall extending perpendicular to a central axis of the stator stack, and guiding body contours. Connecting bodies connect the cophasal coil windings with each other. Each of the connecting bodies comprises a connecting body contour. The connecting body contours engage with the corresponding guiding body contours. Isolating bodies electrically isolate the non-cophasal coil windings from each other. The winding ends extend at a common axial end of the stator beyond the stator stack into the guiding body.

### CROSS REFERENCE TO PRIOR APPLICATIONS

This application is a U.S. National Phase application under 35 U.S.C. §371 of International Application No. PCT/EP2014/075025, filed on Nov. 19, 2014 and which claims benefit to German Patent Application No. 10 2013 113 363.0, filed on Dec. 3, 2013. The International Application was published in German on Jun. 11, 2015 as WO 2015/082220 A2 under PCT Article 21(2).

### FIELD

The present invention relates to a stator for an electronically commutated direct current motor having a stator stack with stator poles between which grooves are defined and on which coil windings are arranged, the winding ends of the coil windings being connected with an electronic circuit via which the commutating signals are adapted to be supplied to the coil windings, wherein cophasal coil windings are connected with each other via connecting bodies and non-cophasal coil windings are electrically isolated from each other via isolating bodies.

### BACKGROUND

Electronically commutated direct current motors having such stators serve, for example, as drive units to adjust control dampers in internal combustion engines or as drive units for pumps or compressors, and have replaced electric motors commutated via brushes to an increasing extent over the past years.

A plurality of electronically commutated motors as well as embodiments of their stators and rotors are known, wherein internal rotor motors are mainly used in the automobile industry. The rotors attached to the drive shaft are equipped with permanent magnets which are attracted according to the magnetic field of the stators to generate the rotation of the stator. The stators comprise pole teeth directed radially inwards around which the stator windings are wound or onto which the ready-wound coils are placed. Both the rotors and the stators are composed of punched-out sheet-metal segments lying one upon another in most cases. In addition to the different conventional embodiments of the stators and rotors, different commutation circuits and position feedback means to provide a proper start of the motor are known. The commutation is effected by energizing the coils via the winding ends which must accordingly be connected with the control unit and thus the current supply. Cophasal winding ends can be supplied via a common supply line so that an electric connection rail is required between these winding ends. It is necessary that the coils and contact lines having different phases be isolated towards each other.

Large currents are also required when these motors are used to drive pumps or compressors in motor vehicles due to the low on-board voltage and high power requirement. Large line cross-sections for the windings are thus required to prevent an excessive heat-up leading to damage of the motor windings. The installation space of such motors should be kept as small as possible and an adequate isolation of the coils towards each other should be provided.

To provide for a contacting of the winding ends in such an electronically commutated direct current motor having large winding cross-sections and to create an isolation between the coils, US 2008/0136274 A1 describes that the U-shaped windings arranged in a spaced relationship to each other in the circumferential direction each comprise two winding ends which axially project from the stator and which are connected with each other via connector plates to form a coil. Each one of the connector plates is composed of a carrier body made of an isolating material as well as of electric connectors which are fastened to the carrier body. A plurality of such connector plates are placed one upon the other and joined by welding with the corresponding winding ends. Corresponding profiles are defined at the ends of the electric connectors therefor, with which the winding ends engage when the connector plates are placed. It is not, however, described how the individual coils can be connected with the current supply and how the creation of a proper desired interconnection is provided.

### SUMMARY

An aspect of the present invention is to provide a stator for an electronically commutated direct current motor via which both a proper connection of cophasal winding ends and their electrical contacting of the control unit and/or current supply is provided. An additional aspect of the present invention is that the installation effort should be kept as low as possible. It is in particular to be provided that the correct winding ends are connected with each other, wherein faulty installation should be prevented. A further aspect of the present invention is to provide the simplest possible adaptation of such motors to changed client data with regard to the required rotational speed, amperage and, consequently, the required winding cross-sections.

In an embodiment, the present invention provides a stator for an electronically commutated direct current motor. The stator includes a stator stack comprising a central axis, stator poles, at least one groove arranged between each of the stator poles, and a coil winding comprising a winding end arranged on each of the stator poles. The winding ends comprise cophasal coil windings and non-cophasal coil windings. The winding ends are connected with an electronic circuit via which commutating signals are adapted to be fed to the coil windings. A guiding body comprises an axial surface arranged opposite to the stator stack, a wall arranged to extend perpendicular to the central axis of the stator stack, and guiding body contours. Connecting bodies are configured to connect the cophasal coil windings with each other and to rest upon the axial surface of the guiding body. Each of the connecting bodies comprises a connecting body contour. The connecting body contours are configured to engage with the corresponding guiding body contours. Isolating bodies are configured to electrically isolate the non-cophasal coil windings from each other and to rest upon the axial surface of the guiding body. The winding ends are configured to extend at a common axial end of the stator beyond the stator stack into the guiding body.

### BRIEF DESCRIPTION OF THE DRAWINGS

The present invention is described in greater detail below on the basis of embodiments and of the drawings in which:

FIG. 1 shows a perspective exploded view of a stator according to the present invention having parallel-connected coils;

FIG. 2 shows a perspective exploded view of an alternative stator according to the present invention having series-connected coils;

FIG. 3 shows a perspective view of a guiding body of the stator according to the present invention of FIG. 1 or 2; and

FIG. 4 shows a perspective view of a stator according to the present invention as shown in FIG. 1 or 2 in an assembled state.

### DETAILED DESCRIPTION

Due to the fact that the winding ends extend, at a common axial end of the stator, beyond the stator stack and into a guiding body which comprises a wall extending perpendicularly to the central axis of the stator stack, at whose axial surface opposite to the stator stack the isolating bodies and the connecting bodies are placed, wherein contours are defined at the connecting bodies, which engage with corresponding contours defined at the guiding body, the position of the connecting body relative to the guiding body and thus to the stator is clearly determined. Incorrect contacting is thus prevented. The position of the winding ends relative to the guiding body as well as to the connecting bodies and isolating bodies is also determined. Installation is thus facilitated and the required installation space is kept small. Using such a stator also helps to realize parallel and series connections so that a motor of the same overall size can easily be adapted to changed rotational speeds.

In an embodiment of the present invention, the corresponding contours of the guiding body in the form of profiles can, for example, be defined at the inner circumference of an axially extending outer wall radially delimiting the guiding body. The outer wall serves as a radial boundary for the isolating and connecting bodies and clearly determines their angular position at the guiding body.

In an embodiment of the present invention, the corresponding contours of the guiding body can, for example, be configured as projections which axially extend from the wall extending perpendicularly to the central axis of the stator stack and face away from the stator. Such an embodiment may serve to additionally or individually fix the position of the bodies in the circumferential direction and in the radial direction.

In an embodiment of the present invention, recesses can, for example, be defined at the guiding body wall extending perpendicularly to the central axis of the stator stack, in which recesses the winding ends are accommodated, so that the winding ends are pre-fixed relative to the guiding body and are thus aligned to fasten to the connecting bodies.

In an embodiment of the present invention, connecting bodies and isolating bodies can, for example, be alternately defined at the wall extending perpendicularly to the central axis of the stator stack. A conducting contact between the connecting bodies is thereby reliably avoided.

In an embodiment of the present invention, through-going windows can, for example, be defined at the connecting bodies, through which windows the winding ends of the coil windings to be contacted extend. The position of the pre-fixed winding ends is thus determined by attaching. Subsequent electrical fastening is thereby easy to perform.

In an embodiment of the present invention, tongues can, for example, be defined at the connecting bodies, at which tongues the winding ends to be contacted are fastened in an electrically conducting manner. The tongues offer the possibility of a large-area contact to fasten the winding ends so that a high durability of the fastening is provided.

In an embodiment of the present invention, the through-going windows can, for example, be defined immediately radially outside the tongues. Fastening can be therefore be effected without shaping the winding ends since they immediately rest upon the tongues due to the fact that they are fastened in the through-going windows.

In an embodiment of the present invention, fastening of the winding ends to the tongues of the connecting bodies can, for example, be effected by a soldered or welded joint. A durable fastening even in the case of vibrations is thereby provided.

In an embodiment of the present invention, contours can, for example, also be defined at the isolating bodies, which contours engage with corresponding contours defined at the guiding body, whereby a correct alignment of the isolating bodies relative to the guiding body and thus to the connecting bodies is attained.

In an embodiment of the present invention, another simplification of the electrical installation is provided when, from each connecting body, connecting contacts axially extend in the direction opposite to the stator stack, via which connecting contacts the coil windings are connected with the electronic circuit via the winding ends. A definite positioning of the connecting contacts to establish the connection with the control unit is thus created.

To provide a complete fixing of the connecting bodies, the isolating bodies and the connecting contacts a terminating ring arranged at the connecting body, the isolating bodies and the connecting bodies, the terminating ring comprising through-going openings through which the connecting contacts extend.

A stator for an electronically commutated direct current motor is thus provided which requires little installation space, is easy to install, and which can be electrically connected in a tolerance-insensitive manner, wherein both a parallel and a series connection of the coils can be realized without the position of the contact connections pointing to the control unit having to be altered. An adaptation of the line cross-sections in the case of changing rotational speeds can thus be realized with only small changes of the stator.

Two exemplary embodiments of a stator according to the present invention are shown in the drawings and are described below.

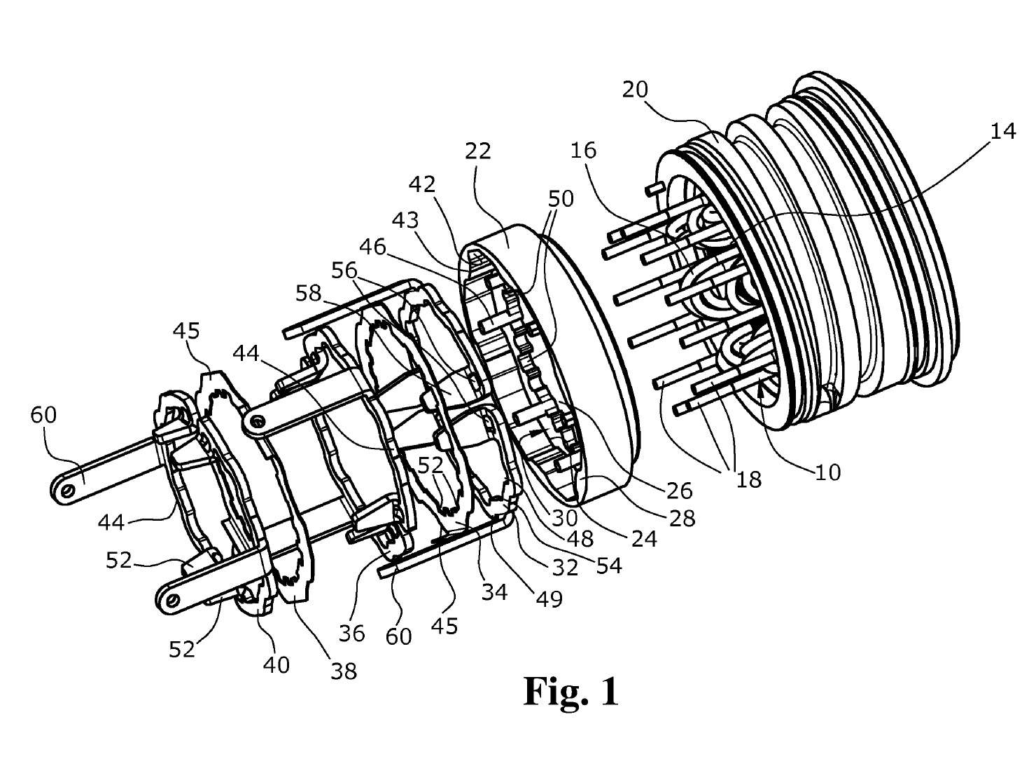

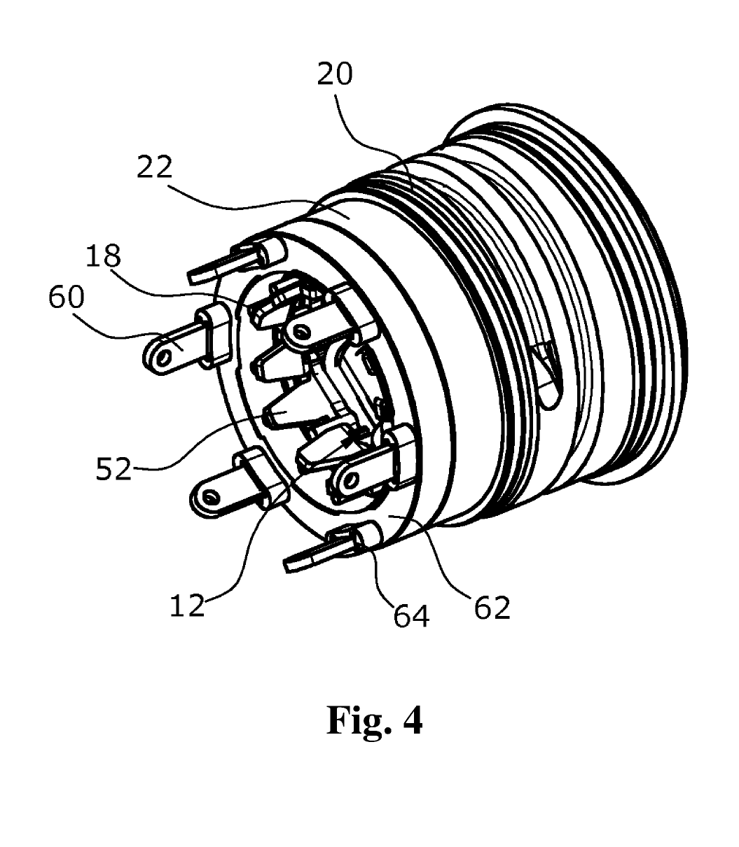

FIGS. 1, 2 and 4 show stators with a wide winding cross-section of electronically commutated three-phase direct current motors configured as inner rotors. The matching rotor is correspondingly inserted, for example, into the interior of the stator and a compressor wheel is attached to its shaft.

The stator is made up of a stator stack 10 which is usually composed of sheet-metal segments lying one upon another. In the exemplary embodiment, the stator stack 10 comprises six stator poles 12 directed radially inwardly, which stator poles 12 are spaced apart from each other by grooves 14. Each stator pole 12 is equipped with a coil winding 16 which is wound around the stator pole 12 and comprises a large cross-section because of the large current flow required. Each coil winding 16 comprises two winding ends 18 which project beyond the stator stack 10 at the common axial end of the stator, the sheet-metal segments of the stator stack 10 being radially surrounded by a stator housing portion 20. The axial end, from which the winding ends 18 project, is open.

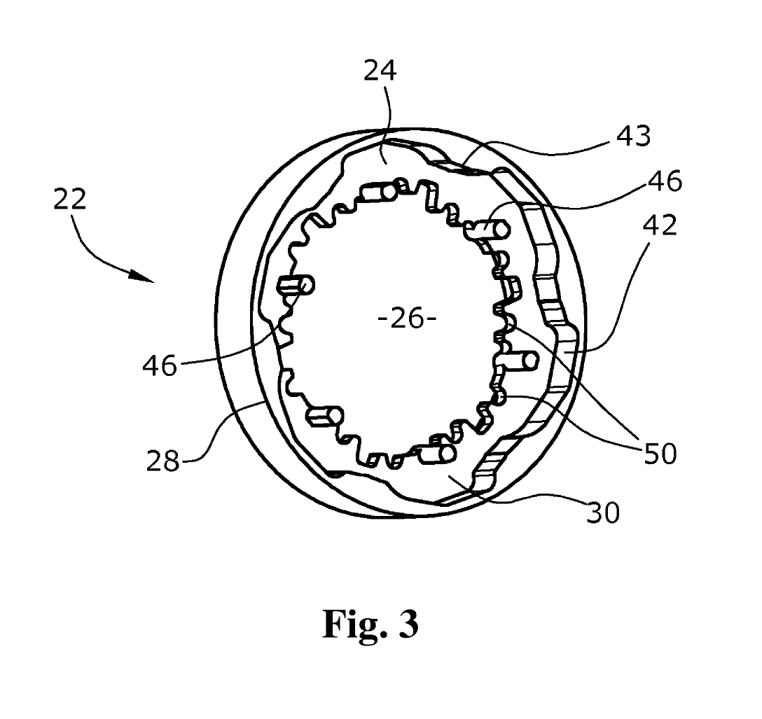

According to the present invention, a guiding body 22 made of an isolating material shown in FIG. 3 is attached to the stator housing portion 20. This guiding body 22 is composed of a wall 24 extending perpendicularly to the central axis of the stator stack 10 and axially arranged on the other side of the stator stack 10, which wall 24 comprises a central opening 26, as well as of an axially extending annular outer wall 28 defining the outer circumference of the guiding body 22 and extending from the wall 24 in a direction opposite to the stator stack 10.

A connecting body 32 is first placed upon a surface 30 which faces away from the stator stack 10 of the wall 24 extending perpendicularly to the central axis of the stator stack 10. This connecting body 32 is followed by an isolating body 34 which is axially placed upon the first connecting body 32. Upon the isolating body 34, a second connecting body 36, a second isolating body 38, as well as a third connecting body 40 is placed.

The outer wall 28 of the guiding body 22 comprises at its outer circumference profiles 42, 43 which correspond to contour 44 at the outer circumference of the connecting bodies 32, 36, 40 and contours 45 at the outer circumference of the isolating bodies 34, 38. Their angular position relative to the guiding body 22 is determined accordingly. In the exemplary embodiment, this radial angular position is additionally determined by pin-shaped projections 46 which axially extend from the inner circumference of the wall 24 extending perpendicularly to the central axis of the stator stack 10 in a direction facing away from the stator stack 10 and to extend into correspondingly shaped recesses 48, 49 at the inner circumference of the connecting and isolating bodies 32, 34, 36, 38, 40. The profiles 42 and the pin-shaped projections 46 thus serve as the contours of the guiding body 22 determining the angular position of the connecting bodies 32, 36, 40 and isolating bodies 34, 38.

Recesses 50 are also defined at the inner circumference of the wall 24 extending perpendicularly to the central axis of the stator stack 10, into which recesses 50 the winding ends 18 extend whose angular position is thus also fixed. Corresponding recesses 52 are also defined at the isolating bodies 34, 38. The connecting bodies 32, 36, 40 also comprise recesses 54 defined at the inner circumference, through which recesses the winding ends 18 extend without touching the connecting bodies 32, 36, 40. These recesses 54 serve as passages of the winding ends 18 which are not to be contacted. Four through-going windows 56 closed radially to the outside are also defined at each connecting body 32, 36, 40, through which through-going windows 56 the winding ends 18 of the two opposite coil windings 16 to be electrically connected via the respective connecting body 32, 36, 40 extend. Immediately radially inside these through-going windows 56, respective axially extending tongues 58 facing away from the guiding body 22 are defined, to which tongues 58 the winding ends 18 are welded to electrically contact the connecting bodies 32, 36, 40. The through-going windows 56 of the various connecting bodies 32, 36, 40 are each offset relative to each other by 60° so that each connecting body 32, 36, 40 connects a different opposite coil pair.

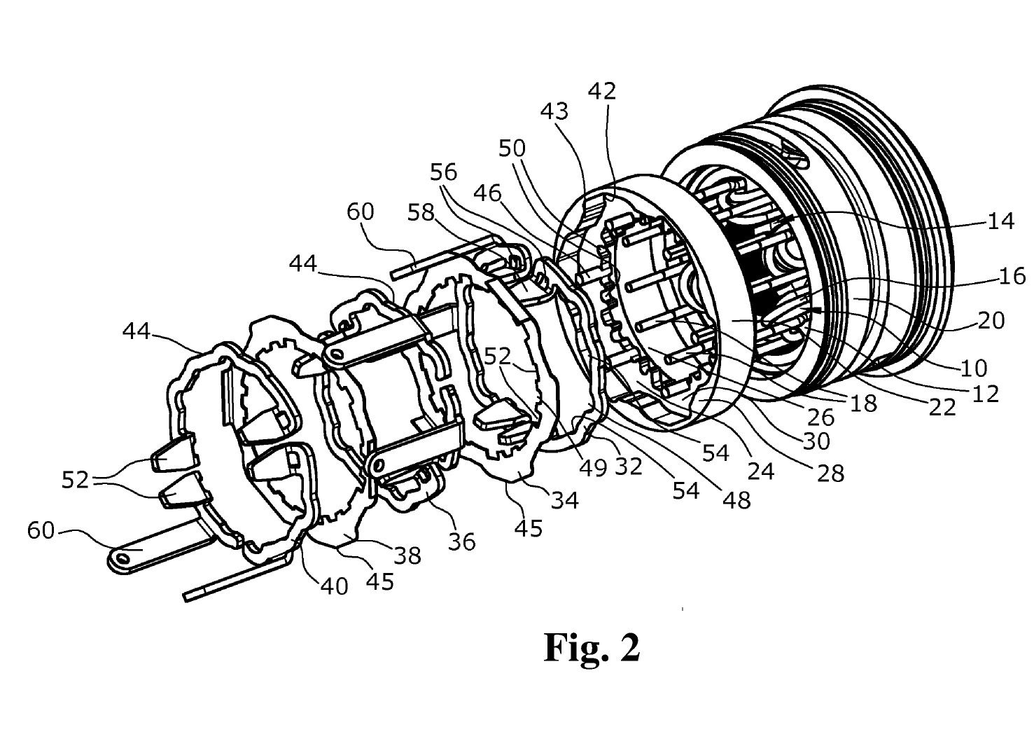

From the radial outer circumference of the connecting bodies 32, 36, 40, two additional connecting contacts 60 per connecting body 32, 36, 40 extend in the axial direction. While in the parallel connection shown in FIG. 1, the connecting contacts 60 are each offset relative to the tongues 58 by approximately 90° and are thus arranged opposite to each other; the connecting contacts 60 in the series connection shown in FIG. 2 are merely offset relative to each other by approximately 60°, which simplifies the respective further contacting in the intended manner.

In the shown exemplary embodiments, the connecting and isolating bodies 32, 34, 36, 38, 40 as well as their contours 44, 48 as well as the contours 42, 50 and pin-shaped projections 46 of the guiding body 22 are configured so that the connecting and isolating bodies 32, 34, 36, 38, 40 are similarly configured and can thus also be offset by 60° . This allows for an inexpensive manufacture.

To complete the stator assembly, a terminating ring 62 is axially placed upon the guiding body 22 and thus also upon the connecting and isolating bodies 32, 34, 36, 38, 40, at which terminating ring 62 six through-going openings 64 are defined through which the connecting contacts 60 project from the stator. These connecting contacts 60 extend into an electronics chamber to a control unit via which the current supply and electronic contacting of the stator are realized in the desired manner.

The illustrated stator is characterized by its very simple installation and good accessibility, wherein series and parallel connections of the coils can be realized by simply exchanging the connecting bodies without the through-hole contacting to the electronics having to be changed. Faulty installation is avoided since no function-relevant interchanging of components is possible. No narrow tolerances must be observed during fabrication of the individual parts since the components are guided towards each other.

It should be appreciated that the scope of protection is not limited to the illustrated exemplary embodiment(s). Motors comprising more or fewer phases can of course be used, wherein the number of the isolating and connecting bodies as well as of the existing contours is to be adapted accordingly. It is further possible to define for each connecting or isolating body its own contours at the body itself and at the guiding body and thus to determine the order and the exact non-rotatable angular position of the bodies without departing from the scope of protection of the main claim. It is further possible to configure the isolating bodies in the form of plastic layers when the connecting bodies have previously been injection-molded. Reference should be had to the appended claims.

What is claimed is:

1-12. (canceled)

13. A stator for an electronically commutated direct current motor, the stator comprising:
a stator stack comprising,
a central axis,
stator poles,
at least one groove arranged between each of the stator poles, and
a coil winding comprising a winding end arranged on each of the stator poles, the winding ends comprise cophasal coil windings and non-cophasal coil windings, the winding ends being connected with an electronic circuit via which commutating signals are adapted to be fed to the coil windings;
a guiding body comprising an axial surface arranged opposite to the stator stack, a wall arranged to extend perpendicular to the central axis of the stator stack, and guiding body contours,
connecting bodies configured to connect the cophasal coil windings with each other and to rest upon the axial surface of the guiding body, each of the connecting bodies comprising a connecting body contour, the connecting body contours being configured to engage with the corresponding guiding body contours, and
isolating bodies configured to electrically isolate the non-cophasal coil windings from each other and to rest upon the axial surface of the guiding body;
wherein,
the winding ends are configured to extend at a common axial end of the stator beyond the stator stack into the guiding body.

14. The stator as recited in claim 13, wherein,
the guiding body further comprises an outer wall arranged to extend axially, the outer wall being configured to radially delimit the guiding body, and
the guiding body contours are configured as profiles at an inner circumference of the outer wall.

15. The stator as recited in claim 13, wherein the guiding body contours are configured as projections which axially extend from the wall perpendicularly to the central axis of the stator stack so as to face away from the stator stack.

16. The stator as recited in claim 13, wherein,
the guiding body further comprises guiding body recesses arranged at the wall, the guiding body recesses being configured to extend perpendicular to the central axis of the stator stack and to accommodate the winding ends.

17. The stator as recited in claim 13, wherein connecting bodies and isolating bodies are alternately arranged at the wall.

18. The stator as recited in claim 13, wherein each of the connecting bodies further comprise through-going windows which are configured to have one of the winding ends of the coil windings to be contacted extend therethrough.

19. The stator as recited in claim 18, wherein each of the connecting bodies further comprise tongues, each tongue being configured to have one of the winding ends be contacted thereto in an electrically conducting manner.

20. The stator as recited in claim 19, wherein each of the through-going windows is arranged immediately radially outside one of the tongues.

21. The stator as recited in claim 19, wherein a respective winding end is fastened to a respective tongue of the connecting bodies via a soldered joint or a welded joint.

22. The stator as recited in claim 13, wherein,
the isolating bodies each comprise isolating body contours, and
the isolating body contours are configured to engage with the guiding body contours.

23. The stator as recited in claim 13, wherein,
each connecting body comprises connecting contacts configured to axially extend in a direction opposite to the stator stack, and
the connecting contacts are configured to connect the coil windings with the electronic circuit via the winding ends.

24. The stator as recited in claim 23, further comprising:
a terminating ring arranged at each of the guiding body, the isolating bodies, and the connecting bodies,
the terminating ring comprising though-going openings configured to have the connecting contacts extend therethrough.
